(19) United States
(12) Patent Application Publication
(10) Pub. No.: US 2017/0312928 A1
(43) Pub. Date: Nov. 2, 2017

(54) VERSATILE SHAVER

(71) Applicant: Headblade, Inc., Gardena, CA (US)

(72) Inventor: Todd Greene, Gardena, CA (US)

(73) Assignee: Headblade, Inc., Gardena, CA (US)

(21) Appl. No.: 15/139,974

(22) Filed: Apr. 27, 2016

(51) Int. Cl. B26B 21/52; B26B 21/22

(52) U.S. Cl. CPC B26B 21/527; B26B 21/225

(57) ABSTRACT

Generally, the present invention provides shavers that are particularly applicable to shaving a user's head, but that may be utilized for shaving any part of the body. More specifically, a shaver according to the present invention has one or more of the following elements: a mounting pivot with a rotating piece where the mounting pivot is on the bottom surface of the body and extends toward the front end of the body, and a wheel rotatingly attached to the bottom surface near the back end wherein an axis of rotation of the wheel is parallel to a cutting edge.

### BACKGROUND OF THE INVENTION

A number of different shaving devices are available, the vast majority of which are primarily designed for shaving a man's face, a woman's legs or other portions of the human torso. In fact, a single design often has been used for shaving many different body areas. The most common multi-purpose designs utilize a substantially straight handle shaped to be grasped by one hand. In these devices, the handle curves or otherwise transitions into a head portion of the device where the razor blade is mounted. The long axis of the razor blades are oriented at right angles to the long axis of the handle, which generally facilitates a straight shaving stroke.

The angle the cutting edge of the blade(s) makes with the surface to be shaved is critical. This “cutting angle” is angle formed between the surface and the plane of the blade with the actual cutting edge in contact with the surface forming the apex of the angle. For effective shaving, the cutting angle should be a relatively small acute angle. In traditional razor systems, if the relationship between the blade and handle is fixed, the plane of the blade approaches being parallel to the long axis of the handle. As such, when the razor is stroked along a surface to be shaved the cutting angle is “automatically” an effective acute angle. In modern “straight handle” razor systems, the blade(s) is held at a predetermined angle in a replaceable cartridge that frames the blade(s). The cartridge, in turn, is mounted on some type of mechanical swivel so the when the cartridge is brought into contact with the surface to be shave, the entire assembly pivots to ensure an optimal cutting angle.

Shaving device designs other than the simple “straight handle razor” are available. For example, U.S. Pat. Nos. Des. 426,918; 6,112,421; 6,018,877; 7,140,115; and 8,782,911, each of which were issued to the present inventor, describe and illustrate different designs that utilize a short body and a hook, either open or closed (e.g. a ring) along the top surface of the device, for engaging a user's finger to assist in manipulating the shaver. The foregoing patents are incorporated by reference herein in their entirety.

The shaver designs disclosed in the foregoing patents have particular applicability to, shaving one's head. However, the present inventor has discovered that additional improvements can be made to provide better results and to enhance the versatility of such shavers.

### SUMMARY OF THE INVENTION

The present invention addresses the identified need for more versatile shavers. In some embodiments, provided herein is a shaving apparatus that comprises a body with a bottom surface, a top surface, a front end, a back end, and a mounting pivot comprising a rotating piece. In these embodiments, the mounting pivot is on the bottom surface of the body and extends toward the front end of the body. The rotating piece on the mounting pivot allows the body of the apparatus to move side to side while the blade stays straight, or the blade to move side to side while the body stays straight. In other words, the rotating piece of the mounting pivot allows the blade/body to move sided to side.

In various embodiments, the shaving apparatus also comprises one or more of a blade attachment clip attached to the mounting pivot, a blade cartridge containing at least one blade connected to the blade attachment clip; a finger hook on the top surface of the body; a grasping region between the front end and the back end of the body; and/or a roller mechanism rotatingly attached to the bottom surface near the back end wherein an axis of rotation of the roller mechanism is parallel to a cutting edge.

In some embodiments, the back end of the body comprises one or more openings, wherein the one or more openings run through the body towards the roller mechanism. In various embodiments, the roller mechanism is a ball or wheel(s). In specific embodiments, the roller mechanism comprises two wheels.

The bottom surface of the shaving apparatus can include a mounting pad. In specific embodiments, the shaving apparatus comprises a finger hook that has a mounting pad. In these embodiments, the mounting pads can be made from any flexible material. In specific embodiments, the flexible material used is rubber.

In one embodiment, the shaving apparatus includes a wishbone piece that is connected to the body of the apparatus at the location of the roller mechanism and runs around the lower surface of the body toward the blade. In specific embodiments, the wishbone piece comprises side pads and a rubber pad where the users thumb can be placed. The wishbone piece used in these embodiments allows the user to shave their legs and arm pits with the same device.

As one of skill in the art would understand upon reading the invention described herein, the shaving apparatus can be made in many different ways. For example, in some non-limiting embodiments, the top surface and bottom surface can be made of different materials. In some embodiments, the top surface is a flexible material and the bottom surface is metal or made from one or more chemical curing materials. In specific embodiments the top surface is rubber. In other specific embodiments, the bottom surface is metal, plastic, or ceramic. In some embodiments, the bottom surface and the mounting pivot are one piece. In these embodiments, the bottom surface and mounting pivot can made from a single mold. In various embodiments, the single mold is made from metal or one or more chemical curing materials. In specific embodiments the single mold is a plastic mold, ceramic mold, or plaster mold.

The present invention also addresses the need for versatile shavers by providing a shaver that has one or more of the following elements: a body comprising a bottom surface, a top surface, a front end, a back end and a mounting pivot comprising a rotating piece, where the mounting pivot is on the bottom surface of the body and extends toward the front end of the body; a blade attachment clip attached to the mounting pivot; a blade cartridge containing at least one blade connected to the blade attachment clip; a finger hook on the top surface of the body; a grasping region between the front end and the back end of the body; and a roller mechanism rotatingly attached to the bottom surface near the back end wherein an axis of rotation of the roller mechanism is parallel to the cutting edge.

In one specific embodiment, the blade cartridge is flexibly attached to the blade attachment clip with a cutting edge of the at least one blade facing the back end of the body. In this embodiment, a hinge (or spring) can be used to attach the blade cartridge to the blade attachment clip. In various embodiments, the flexibility of the blade attachment clip allows the device move vertically while in use. For example, when pressure pushes down on the body the blade also moves down and when the pressure is released, the body moves back up.

In various embodiments, the blade attachment clip comprises at least one inward projection and the blade cartridge is attached to the inward projection. The blade attachment clip and the blade cartridge can be unitary or the blade cartridge is removably attached to the blade attachment clip. In some embodiments of the invention, the body and the blade cartridge are configured such that when the shaving apparatus is placed on a planar surface with the lower surface facing the planar surface, only an edge of the blade cartridge farthest from the roller mechanism and the roller mechanism contact the planar surface.

A mounting pivot with a rotating piece allows the blade to move from side to side when a user is shaving, which permits the user to turn into the blade when using the shaver described herein. In embodiments where a hinge attaches the blade cartridge to the blade attachment clip, the blade is also allowed to move vertically when a user is shaving. Inward projections are used to attach the blade cartridge to the blade attachment clip.

A roller mechanism on the same side as the razor blade, an adjustable finger hook for accommodating fingers of different sizes and a narrowing or “waist” in the shaver body facilitates grasping the device when shaving the user's face. The waist allows the shaver to be grasped for shaving the face, and when compared to straight handle razors, grasping this shaver at the waist with the index finger accommodated by the protuberance results in improved stability and control of the razor.

A blade clip and the attached blade are disposed at the rear end of the shaver body. A roller mechanism is mounted at the end of the shaver opposite the blade. The cutting edge of the blade is disposed so that the shaving stroke moves towards the roller mechanism.

The clip results in a two point contact when the shaver is placed on a planar surface. That is, only the roller mechanism and the rearmost edge of the cartridge touch the surface. A resilient plastic spring arm allows the cartridge to flex at its attachment point so that downward pressure on the shaver will cause the entire cartridge to flex so that it is parallel to the planar surface on which it rests.

A finger hook and pads are provided for gripping the shaver to shave the user's scalp. In a preferred embodiment the pad nearest the blade is associated with an overarching protuberance extending from the hook. The user's index or middle finger can be inserted through the hook in a “palm grip” which allows ready shaving of the scalp.

The indentation or “waist” allows a user to grasp the shaver between the fingers and the thumb much like a traditional straight handle razor with the user's index finger advantageously accommodated by the protuberance. For some parts of the body, this “waist grip is preferred. For other areas of the body, the “palm grip” is more effective. This single versatile configuration can be used to shave virtually all regions of the body.

By virtue of the foregoing arrangements, a shaver can be provided that often has improved comfort and friction reduction, as well as providing the user with better control in certain circumstances. The present invention is well-suited to shavers having a finger hook or other means for grasping the shaver along the top of the main body to shave, for example, the user's scalp.

### BRIEF DESCRIPTION OF THE DRAWINGS

FIG. 1 illustrates a right-side elevational view of the shaver device with a closed finger hook and two wheels, according to one embodiments of the invention.

FIG. 2 illustrates a left-side elevation view of the shaver device with a closed finger hook and a mounting pivot comprising a rotating piece, according to one embodiments of the invention.

FIG. 3 illustrates a top perspective view of the shaver device with a mounting pivot comprising a rotating piece, according to another embodiment of the invention.

FIG. 4 illustrates a side perspective view of the shaver device with a closed finger hook and a mounting pivot comprising a rotating piece, according to another embodiment of the invention.

FIG. 5 illustrates a bottom perspective view of the shaver device with a mounting pivot comprising a rotating piece, according to one embodiment of the invention.

FIG. 6 illustrates a back perspective view of the shaver device with a mounting pivot comprising a rotating piece, according to one embodiment of the invention.

FIG. 7 illustrates a side perspective view of the shaver device with a mounting pivot comprising a rotating piece and a more open finger hook, according to one embodiment of the invention.

FIG. 8 illustrates a side perspective view of the shaver device with a mounting pivot and a wishbone piece connected to the body of the apparatus at the location of the roller mechanism, according to one embodiment of the invention.

FIG. 9 illustrates a bottom perspective view of the shaver device with a mounting pivot and a wishbone piece, according to one embodiment of the invention.

FIG. 10 illustrates a side perspective view of the shaver device with a mounting pivot and body as a single piece, according to another embodiment of the invention.

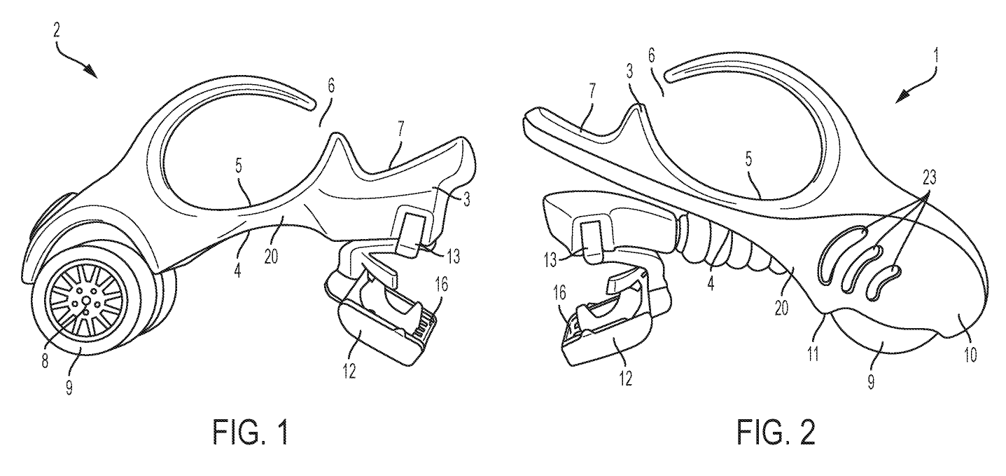

Other objects, features and advantages of the devices described herein will become apparent from the following detailed description. It should be understood, however, that the detailed description, while indicating specific embodiments, is given by way of illustration only, since various changes and modifications within the spirit and scope of the instant disclosure will become apparent to those skilled in the art from this detailed description.

### DETAILED DESCRIPTION OF THE INVENTION

The attached figures illustrate a shaver that is similar to the shavers disclosed in the '115, 918, '421 and '877 patents, but includes several additional features that are not disclosed in those patents. These differences significantly extend the range of use of the shaver. Thus, unlike the prior art designs embodiments of this device can be used to shave the head, torso, legs, arm pits or face.

Like the shavers disclosed in the '115, 918, '421 and '877 patents, shaver 1 utilizes a relatively short main body 3 (e.g., about 65-70 mm in length) that is also taller than most conventional shavers (e.g., about 40 mm in height, including the finger hook 6). The main body 3 is wider at the front where the razor blade attachment clip 13 is attached (e.g., about 40 mm wide) than at the rear end where the roller mechanism 10 is attached (e.g., about 13 mm wide). While the illustrated and described configurations and dimensions are believed to be ideal for ease-of-use, the shaver disclosed herein may have any variety of other shapes and/or size.

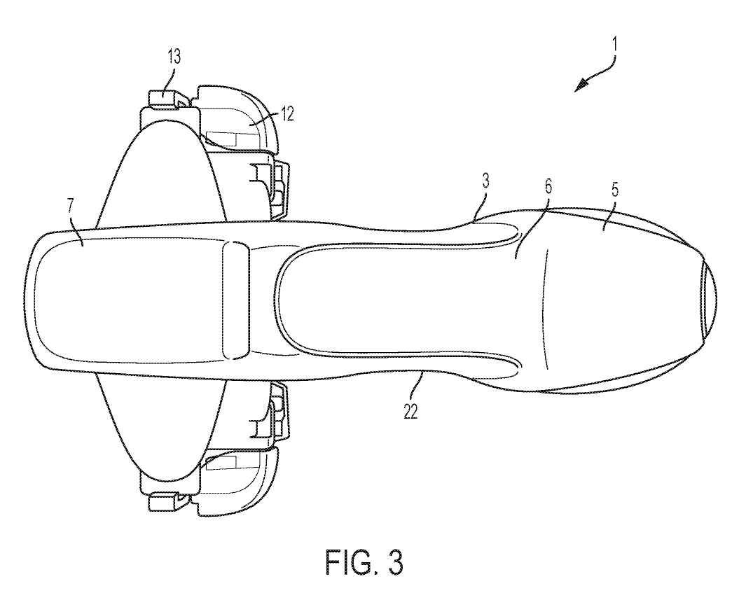

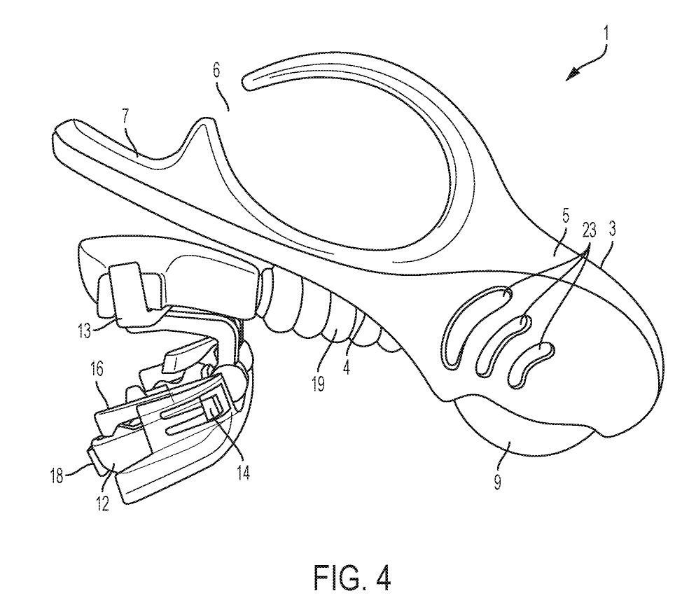

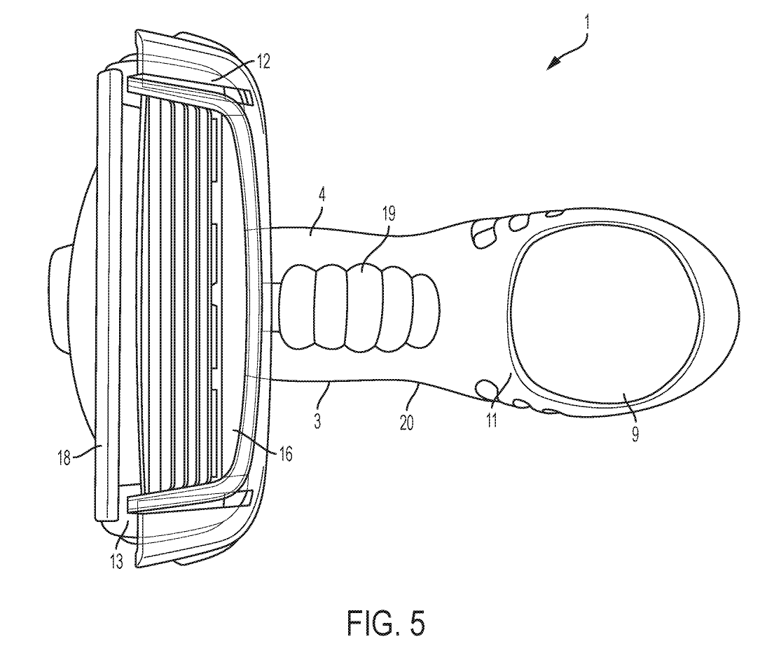

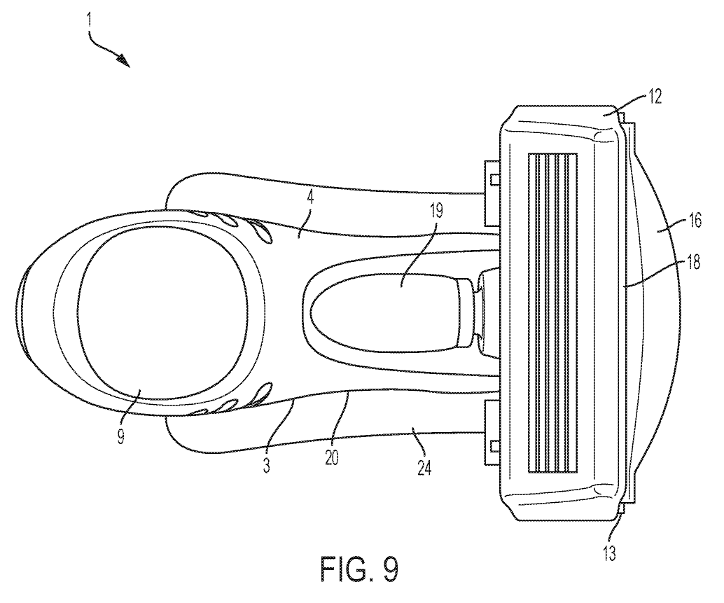

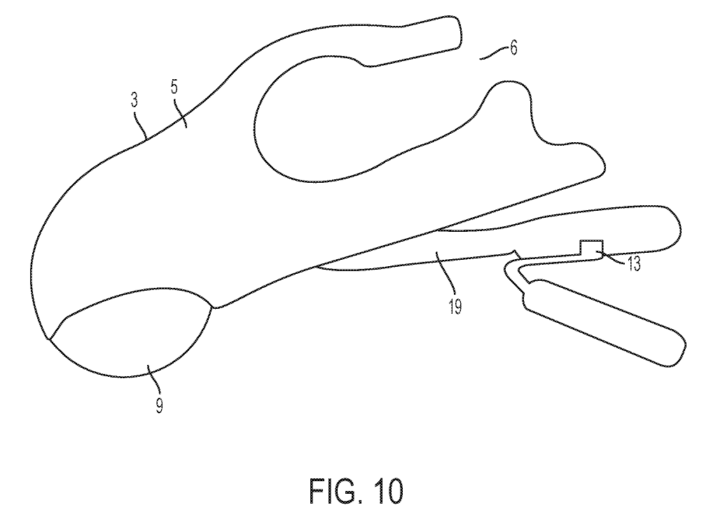

FIGS. 2-10 show various embodiments of the shaver of the current invention. Although superficially similar to the shavers disclosed in the '115, 918, '421 and '877 patents, there are a number of significant differences. As illustrated in FIGS. 3 and 5, the body 3 is less of a triangular shape with the blade 12 being wider than the body 3, including the rear end of the roller mechanism 11. In specific embodiments, the razor blade attachment clip 13 includes inward projections 14 (FIG. 4) for permitting a razor blade 12 to be pivotally attached to shaver 1.

In specific embodiments, razor blade attachment clip 13 is readily detachable and re-attachable to mounting pivot 19 of shaver 1. The razor blade 12 can be a conventional disposable razor blade cartridge that includes the blade itself and a supporting cartridge. Usually, razor blade 12 is installed onto blade attachment clip 13 so that its cutting edge faces toward the front end of shaver 1, meaning that shaving will occur when shaver 1 is moved along the skin in a cutting direction such that the front end razor blade 12 is the leading end of the device. However, in other embodiments the razor blade 12 can be installed in the reverse manner so that the back is the leading end of the device.

Similar to the shaver disclosed in the '911 patent, shaver 1 includes a finger hook 6 to surround both sides of an inserted finger and pads 7 for allowing the stabilized manipulation of shaver 1. Pads 7 may be attached to the main body 3 of shaver 1 in any of a variety of different ways. For example, they may be snap-fitted or glued onto main body 3. Alternatively, pads 6 may even be integrally formed as a part of main body 3, e.g., by using a different texture for the surfaces of main body 3 that are to be designated as the pad areas.

Similar to the shaver devices disclosed in the '911 and '115 patents, shaver 1 and shaver 2 include a roller mechanism 9 on the rear end 11 of shaver 1. In shaver 2, the roller mechanism 9 is implemented as two separate wheels which are attached to the main body 3 using an axle that passes through at least one guiding hole 8 in the bottom portion of rear end of shaver 2 and that attaches to the two wheels.

As one of skill in the art will understand upon reading this disclosure, various temporary attachment mechanisms may be utilized to attach the roller mechanism 9 to the main body 3 of a shaver 1 or 2. One preferred configuration for temporarily attaching the axle to the roller mechanism is to use a mating male-and-female snap-fit construction. Specifically, in one embodiment of this invention, the roller mechanism is a wheel and the axle has a flexible but resilient ball at each end and each wheel has a channel that has a fixed width other than a wider ball-shaped portion within the interior of wheel. As a result, when the axle is pressed into the channel, the ball is initially deformed and then returns to its normal shape once it enters, thereby locking the wheel onto the axle. In these embodiments, in order to facilitate the attachment to axle, the material of the wheels and/or the surrounding channel may be flexible but resilient. In various embodiments, the roller mechanism 9 can be easily removed (e.g., by pulling with sufficient force), thereby permitting it to be interchanged with other replacement roller mechanisms.

In some embodiments, more permanent techniques are used to secure one or more wheels 9 to an axle. For example, each wheel 9 may include a hole 8 that extends all the way through the center of such wheel 9. The axle is then inserted through such hole and the end of the axle is permanently deformed so that it will be wider than the hole through the wheel 9. The use of an axle in such a manner restricts motion of the wheel 9 to rotation through a single axis parallel to the cutting edge 18 of razor blade 12 in the present embodiment. As a result, this configuration often will only permit back and forth motion in a single dimension. In many cases, such a restriction may be desirable in that it may help to prevent accidental lateral motion which may result in nicking or cutting.

In some embodiments, it may be more desirable to utilize a wheel configuration that facilitates movement in more than one dimension. Such a feature might be desirable, for example, where a curved razor blade or a blade other than the standard straight safety razor blade is to be utilized. In this case, a ball-and-socket configuration may be utilized in which wheel 9, rather than being cylindrically shaped, is spherically shaped and is fitted into a ball-shaped socket joint.

In either event, the provision of a roller mechanism 9 on the rear end 11 of a shaver 1 facilitates the movement of shaver 1 during the shaving process, frequently resulting in a smoother shaving experience. In the absence of such a roller mechanism 9, the rear end of shaver 1 may encounter stubble or other obstacles that interfere with such shaving and/or may unintentionally scrape off shaving lotion before the blade 18 has reached that portion of the user's skin.

In one embodiment, the blade attachment clip 13 and the attached blade/cartridge 12 are disposed at the blade end of the body 3 with the cutting edge of the blade pointing towards the roller mechanism end 11. Therefore, the shaving stroke direction in this device is towards the roller mechanism 9 rather than away from it. The finger hook 6 and pads 7 are somewhat reconfigured. The finger hook 6 is formed in two parts so as to surround both sides of an inserted finger.

The blade attachment interface 13 results in a two point contact when the shaver 1 is placed on a planar surface. That is, only the roller mechanism 9 and the rearmost edge of the blade cartridge 12 touch the surface. The cartridge 12 is preferably hingedly attached to the blade attachment clip 13 at the frontmost edge of the cartridge so that a resilient plastic spring arm allows the cartridge 12 to flex at the attachment point. Downward pressure on the shaver 1 will cause the entire cartridge 12 to reorient so that it is parallel to the planar surface on which it rests.

FIG. 3 shows the shaver 1 viewed from above and demonstrates that the body 3 is less of a triangle shape than previous devices and has one of more indentations between the front end and the rear end. These indentations form a “waist” 22, which allows a user to grasp the razor between the fingers and the thumb much like a traditional straight handle razor.

FIG. 4 illustrates the shaver 1 in an upward-left orientation. This device includes a rotating piece on a mounting pivot 19, which allows the blade 12 to rotate on a specific axis when a user is shaving. The rotating piece of the mounting pivot 19 allows the user to turn into the blade 12 when using the shaver 1. In various embodiments, a hinge attaches the blade cartridge 12 to the blade attachment clip 13 allowing the blade to move vertically when a user is shaving. Inward projections 14 are used to attach the blade cartridge 12 to the blade attachment clip 13.

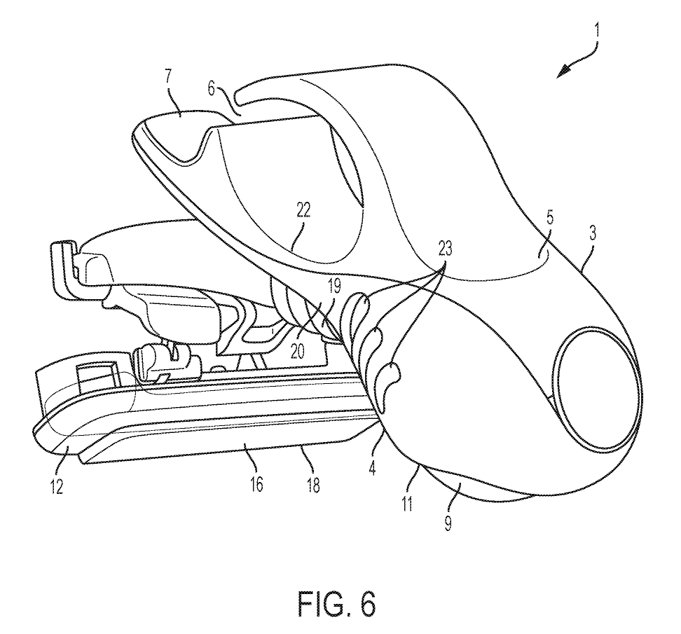

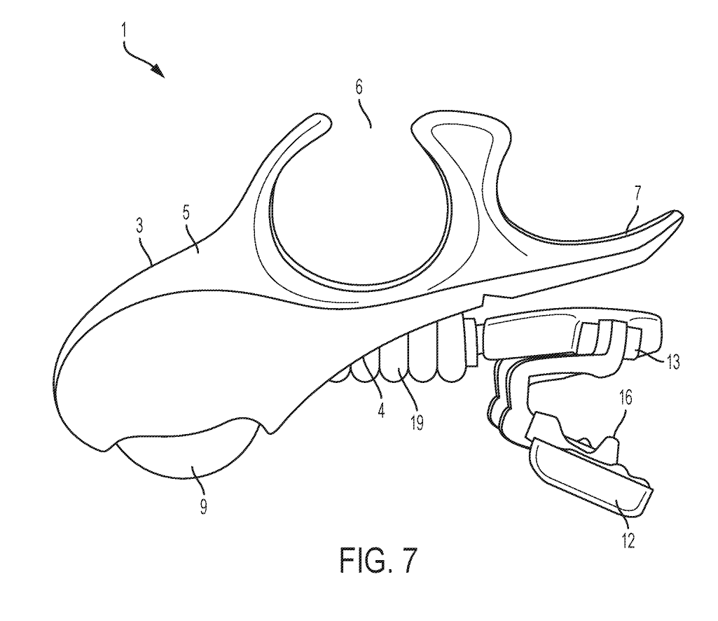

FIG. 6 illustrates a back perspective view of the shaver device with a mounting pivot 19 and closed finger hook 6, while FIG. 7 illustrates a side perspective view of the shaver device with a rotating piece on the mounting pivot 19 and a more open finger hook 6. Openings 23 on the body 3 of the devices shown in the figures provided allow the rotating mechanism to be cleaned.

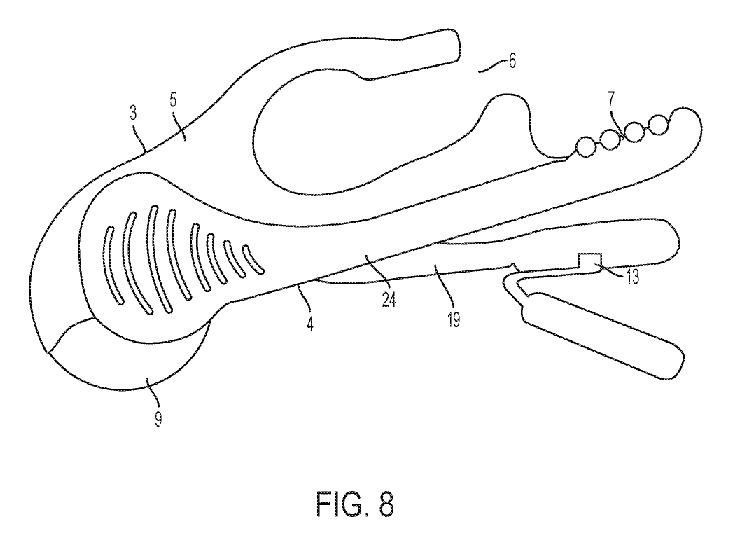

FIG. 8 illustrates a side perspective view of a shaver device with a mounting pivot 19 and a wishbone piece 24 connected to the body 3 of the apparatus at the location of the roller mechanism 9. This device includes a finger hook pad 6, a mounting pad on the lower surface of the body (not shown) and pads on the side of the device (not shown). The wishbone piece and extra pads in this embodiment allow the user to move his/her hand on the device so that they can shave their legs and arm pits with ease using a single shaver.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent presently preferred embodiments of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A shaving apparatus comprising:
a body comprising a bottom surface, a top surface, a front end, a back end, and a mounting pivot, wherein the mounting pivot is on the bottom surface of the body, extends toward the front end of the body and comprises a rotating piece; and
a roller mechanism rotatingly attached to the bottom surface near the back end wherein an axis of rotation of the roller mechanism is parallel to a cutting edge.

2. The shaving apparatus of claim 1, further comprising a blade attachment clip attached to the mounting pivot.

3. The shaving apparatus of claim 2, further comprising a blade cartridge containing at least one blade connected to the blade attachment clip.

4. The shaving apparatus of claim 3, wherein the rotating piece on the mounting pivot allows the body to move side to side while the blade stays straight.

5. The shaving apparatus of claim 3, wherein the rotating piece on the mounting pivot allows the blade to move side to side while the body stays straight.

6. The shaving apparatus of claim 1, wherein the back end of the body comprises one or more openings, wherein the one or more openings run through the body towards the roller mechanism.

7. The shaving apparatus of claim 1, further comprising a finger hook on the top surface of the body.

8. The shaving apparatus of claim 1, further comprising a grasping region between the front end and the back end of the body.

9. The shaving apparatus of claim 2, wherein the blade attachment clip is removably attached to the mounting pivot.

10. The shaving apparatus of claim 1, wherein the bottom surface comprises a mounting pad.

11. The shaving apparatus of claim 7, wherein the finger hook comprises a mounting pad and the mounting pads on the finger hook and the bottom surface are made from a flexible material.

12. The shaving apparatus of claim 11, wherein the flexible material is rubber.

13. The shaving apparatus of claim 1, wherein a wishbone piece is connected to the body at the location of the roller mechanism and runs around the lower surface of the body.

14. The shaving apparatus of claim 13, wherein the wishbone piece comprises side pads and a rubber pad where a thumb would sit.

15. The shaving apparatus of claim 13, wherein the wishbone piece allows a user to shave a leg and an arm pit with the same shaving apparatus.

16. The shaving apparatus of claim 1, wherein the top surface and bottom surface are made of different materials.

17. The shaving apparatus of claim 16, wherein the top surface is a flexible material and the bottom surface is metal or made from one or more chemical curing materials.

18. The shaving apparatus of claim 17, wherein the flexible material is rubber.

19. The shaving apparatus of claim 17, wherein the bottom surface is plastic or ceramic.

20. The shaving apparatus of claim 1, wherein the bottom surface and the mounting pivot are one piece.

21. The shaving apparatus of claim 20, wherein the bottom surface and the mounting pivot are made from a single mold.

22. The shaving apparatus of claim 21, wherein the single mold is made from metal or one or more chemical curing materials.

23. The shaving apparatus of claim 21, wherein the single mold is a plastic mold, a ceramic mold, or a plaster mold.

24. The shaving apparatus of claim 1, wherein the roller mechanism comprises a wheel.

25. The shaving apparatus of claim 1, wherein the roller mechanism comprises a ball.

26. The shaving apparatus of claim 3, wherein the blade cartridge is flexibly attached to the blade attachment clip with a cutting edge of the blade facing the back end of the body.

27. The shaving apparatus of claim 8, wherein the grasping region comprises at least one indentation in the body.

28. The shaving apparatus of claim 3, wherein the body and the blade cartridge are configured such that when the shaving apparatus is placed on a planar surface with the lower surface facing the planar surface, only an edge of the blade cartridge farthest from the roller mechanism and the roller mechanism contact the planar surface.
